(19) United States
(12) Patent Application Publication
(10) Pub. No.: US 2014/0156737 A1
(43) Pub. Date: Jun. 5, 2014

(54) METHOD FOR CONTROLLING INFORMATION PROCESSING APPARATUS AND INFORMATION PROCESSING APPARATUS

(71) Applicant: FUJITSU LIMITED, Kawasaki-shi (JP)

(72) Inventors: Tomoharu Imai, Kawasaki (JP); Kazuki Matsui, Kawasaki (JP)

(73) Assignee: FUJITSU LIMITED, Kawasaki-shi (JP)

(21) Appl. No.: 14/093,942

(22) Filed: Dec. 2, 2013

(30) Foreign Application Priority Data
Dec. 4, 2012 (JP) 2012-265822

(51) Int. Cl. H04L 29/06

(52) U.S. Cl. CPC H04L 67/42
USPC 709/203

(57) ABSTRACT

A method of controlling an information processing apparatus includes acquiring image information updated when an operation position specified based on operation information is set to a position different from the operation position, and setting the operation position to the position based on the image information acquired in the acquiring.

### CROSS-REFERENCE TO RELATED APPLICATION

This application is based upon and claims the benefit of priority of the prior Japanese Patent Application No. 2012-265822, filed on Dec. 4, 2012, the entire contents of which are incorporated herein by reference.

### FIELD

The embodiments discussed herein are related to a method of controlling an information processing apparatus and an information processing apparatus.

### BACKGROUND

The thin client system is a system which manages applications and data at a server while permitting a client to have only the minimum function. Further, so-called mobile thin client system by which in-house applications and data are securely used in mobile environments has been demanded along with the spread of terminal devices such as a tablet terminal and a smartphone.

As a related technique of related art, there is a technique for executing visual representation for moving a cursor on a screen along an operation direction which is inputted from a client until a selection state of icons which are arranged on the screen transits after a direction indication operation by the client starts. Further, there is a technique for switching to an enlargement mode in which a partial region of a screen of a client is displayed in an enlarged manner, in accordance with an operation of a user. Further, there is a technique for enlarging a display element which is instructed to be displayed in an enlarged manner when an instruction to enlarge the display element which is displayed on a small display screen such as that of a terminal device is issued, and for executing an instruction corresponding to a display element when the display element which is enlarged and displayed is selected. Further, there is a technique for displaying a partial region including an enlarging object in an enlarged manner when a positional relationship between a coordinate position on a display screen and a display position, on the display screen, of the enlarging object which is an object of enlargement satisfies a predetermined condition. Further, there is a technique in which when an operation event on a screen is recognized, a cursor having a frame surrounding an operation object position, which is a position having offset between an operation detection position of the operation event and the operation object position, is displayed on the screen. (For example, refer to Japanese Laid-open Patent Publication No. 2011-100415, Japanese Laid-open Patent Publication No. 2012-093940, Japanese Laid-open Patent Publication No. 11-272387, Japanese Laid-open Patent Publication No. 2009-116823, and Japanese Laid-open Patent Publication No. 2012-043266.)

### SUMMARY

According to an aspect of the invention, a method of controlling an information processing apparatus includes acquiring image information updated when an operation position specified based on operation information is set to a position different from the operation position, and setting the operation position to the position based on the image information acquired in the acquiring.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a correction method according to embodiments;

FIG. 2 illustrates a system configuration example of a thin client system;

FIG. 3 is a block diagram illustrating a hardware configuration example of a server;

FIG. 4 is a block diagram illustrating a hardware configuration example of a client device;

FIG. 5 is a block diagram illustrating a functional configuration example of a server according to a first embodiment;

FIG. 6 is a block diagram illustrating a functional configuration example of a client device;

FIG. 7 illustrates an example of a storage content of correction complementary information;

FIG. 8 is an explanatory diagram (I) illustrating an operation example of correction processing according to the first embodiment;

FIG. 9 is an explanatory diagram (II) illustrating an operation example of the correction processing according to the first embodiment;

FIGS. 10A and 10B illustrate a selection example of a cursor ID in which edge detection is used;

FIG. 11 is a flowchart illustrating an example of a drawing processing procedure performed by the client device;

FIG. 12 is a flowchart illustrating an example of a drawing processing procedure performed by the server;

FIG. 13 is a flowchart illustrating an example of a correction processing procedure according to the first embodiment;

FIG. 14 is a flowchart illustrating an example of a processing procedure for selecting a mesh region by using the edge detection in processing of step S1306;

FIG. 15 is a block diagram illustrating a functional configuration example of a server according to a second embodiment;

FIG. 16 illustrates an example of a storage content of correction update region information;

FIG. 17 is an explanatory diagram (I) illustrating an operation example of correction processing according to the second embodiment;

FIG. 18 is an explanatory diagram (II) illustrating an operation example of the correction processing according to the second embodiment;

FIGS. 19A, 19B, 19C and 19D (hereinafter 19A to 19D) illustrate an example of a display position of image information of an enlarged image; and

FIG. 20 is a flowchart illustrating an example of a correction processing procedure according to the second embodiment.

### DESCRIPTION OF EMBODIMENTS

However, according to the related art, it is difficult for a user who uses a terminal device such as a tablet terminal to perform an operation with respect to a narrow region which is in a screen of the terminal device and is hard to be designated. For example, when a user performs an operation with respect to a narrow region which is hard to be designated, a region which is different from a region intended by the user may be designated. Further, when a region is enlarged and displayed by an operation of a user for easier operation, an operation amount of the user is increased.

A correction method, a system, an information processing device, and a correction program according to embodiments of the present disclosure are described in detail below with reference to the accompanying drawings.

(An Example of Correction Method)

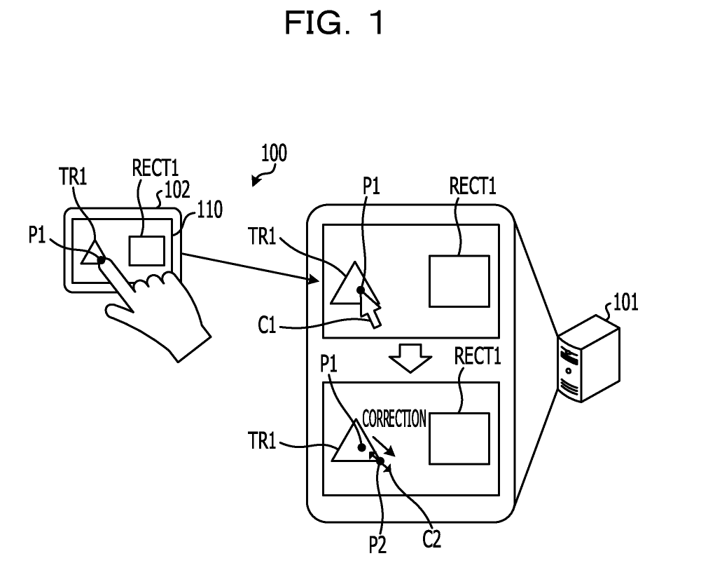

FIG. 1 illustrates an example of a correction method according to embodiments. In FIG. 1, a system 100 includes an information processing device 101 and a terminal device 102. The system 100 is a thin client system which permits the terminal device 102 to have the minimum function and manages applications and data in the information processing device 101, for example.

The information processing device 101 is a computer which is communicable with the terminal device 102 via a network. Further, the information processing device 101 has a function to generate image information of an image which is to be displayed on a display screen 110 of the terminal device 102 and transmit the image information of the image to the terminal device 102. The information processing device 101 is a server, for example. An operating system (OS) executed by the server does not depend on a specific architecture and any OS may be employed.

The image is an image of a screen for displaying an execution result of application software which is executed in the information processing device 101 in response to a request of the terminal device 102. The application software is a designing support tool, presentation software, spreadsheet software, electronic mail software, and the like, for example. The image information is data of computer aided design (CAD) which is used for drawing, catalog data of products, and the like, for example. Application software is referred to as “application” below.

The terminal device 102 is a computer which is communicable with the information processing device 101 via a network. Further, the terminal device 102 includes the display screen 110 and has a function to display an image on the display screen 110 on the basis of image information which is received from the information processing device 101. The terminal device 102 is a tablet terminal, a notebook personal computer (PC), a smartphone, a mobile telephone, a mobile music player, or the like, for example.

Here, when the terminal device 102 is a tablet terminal, a smartphone, or a mobile telephone, a user interface which is provided to a user by the terminal device 102 may be different from a user interface which is expected by an application which is executed by the information processing device 101. In this case, it may be hard for a user who operates the terminal device 102 to operate an application which is executed by the information processing device 101.

Specifically, there is a case in which the terminal device 102 specializes in a touch operation as a user interface and a user interface which is expected by an application which is executed by the information processing device 101 is expected to be an operation operated by a mouse. Regarding a touch operation, it is difficult for a user to perform designation by the touch operation with respect to a region narrower than the size of a user's finger. On the other hand, the user is capable of easily performing click, drag, and the like with respect to a narrow region having a size of a several pixels through an operation using a mouse. Thus, in a case in which an application which is executed by the information processing device 101 is developed while expecting a user interface which enables easy performance of click, drag, and the like with respect to a narrow region, it is difficult for a user who operates the terminal device 102 to execute the application which is executed by the information processing device 101.

An operation with respect to a narrow region in which it is difficult to perform designation may occur even if both of the information processing device 101 and the terminal device 102 provide an operation operated by a mouse. For example, there is a case in which the number of pixels of a screen of the terminal device 102 is small and the number of pixels of a screen of the information processing device 101 is large. Further, even if the number of the screen of the information processing device 101 and the number of pixels of the screen of the terminal device 102 are same as each other, a user who uses the terminal device 102 may be bad at performing an operation by a mouse with respect to a narrow region.

As a technique for facilitating a touch operation with respect to a narrow region, there are two techniques described below. The first technique is a technique in which an enlarged screen around a touched part is displayed on the terminal device 102 so as to display a current coordinate position which is touched in the enlarge screen for a user. However, a coordinate position is changed by minute movement of a finger in the first technique. Further, the user adds an operation process so as to display an enlarged screen in the first technique.

The second technique is a technique in which a cursor is moved to a specific position when a specific operation instruction is executed. The specific position is a position on which an OK button in a dialogue is arranged, a position on which a cancellation button is arranged, or the like, for example. However, an instruction handled by an OS or an application is interpreted so as to specify a specific position, increasing the degree of dependence on the OS and the application, in the second technique. Further, it is hard to handle an application which is newly added to the information processing device 101.

Therefore, the information processing device 101 according to first and second embodiments corrects a position of a touch operation which has been performed on a screen of the terminal device 102 to a position on which a display image is changed for a visual effect when a cursor is virtually moved in the periphery of the position of the touch operation. The information processing device 101 according to the first embodiment corrects the position to a position on which an image of a cursor is changed for the visual effect when the cursor is moved. Accordingly, the information processing device 101 facilitates a touch operation with respect to a narrow region which is difficult to be designated by a finger.

In FIG. 1, the terminal device 102 displays a triangle TR1 and a rectangle RECT1. Here, it is assumed that an operation user desires to enlarge or reduce the size of the triangle TR1. The terminal device 102 receives operation information of a touch operation which is performed on the display screen 110 through an operation by the user. In FIG. 1, an operation position which is specified by the operation information is an operation position P1. The terminal device 102 transmits the received operation information to the information processing device 101.

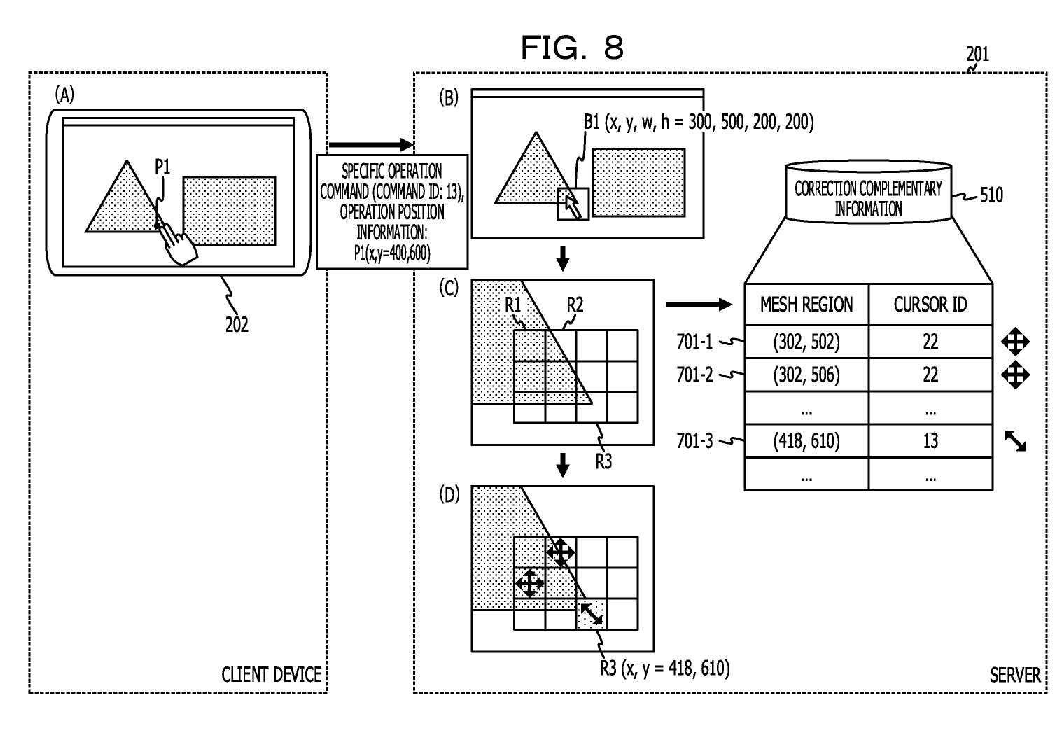

When receiving the operation information, the information processing device 101 acquires image information of an update region, which is updated when the operation position P1 is set to each coordinate position, of the display screen 110, for each of coordinate positions in a predetermined range from the operation position P1. The predetermined range is a range which is obtained by expanding a region around the operation position P1 which is a center by a threshold value, for example. A designating method of a threshold value will be described with reference to FIG. 8. Further, each of the coordinate positions may include the operation position P1. Hereinafter, the predetermined range is referred to as a “search range”.

Image information of an update region includes an ID for specifying an image included in the update region, image data of the update region based on an image format, and a hash value of the image data of the update region. The image format may be an array of uncompressed RGB values, microsoft windows® BitMap image (BMP), or an image format such as graphics interchange format (GIF) and joint photographic experts group (JPEG). In the example of FIG. 1, the information processing device 101 acquires a hash value of image data of a cursor which is included in the update region, as image information of the update region. A hash value is preferably obtained by the hash algorithm with little collision, and the hash algorithm is message digest algorithm 5 (MD5), for example.

In the example of FIG. 1, the information processing device 101 acquires a hash value of image data of a normal cursor C1 on the operation position P1. Further, the information processing device 101 acquires a hash value of image data of a cursor C2 on a position P2 which is in the search range. The cursor C2 indicates that it is possible to enlarge or narrow the triangle TR1 in size by dragging. Here, an application which is executed by the information processing device 101 is developed on the assumption of an operation by a mouse, so that a region in which the cursor C1 changes into the cursor C2 is a narrow region.

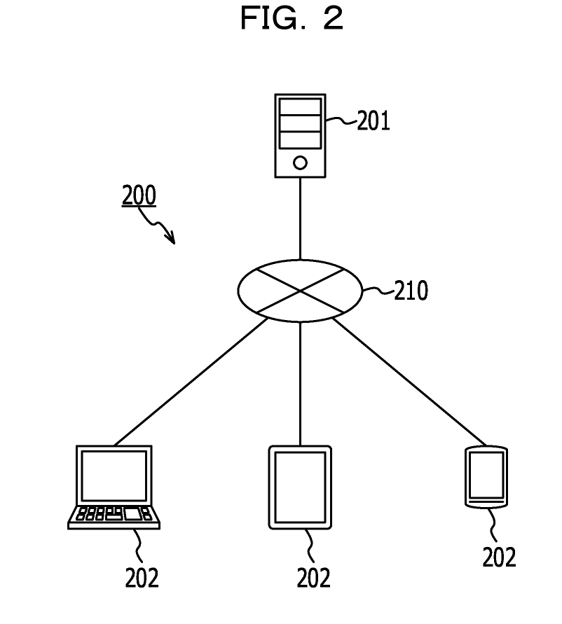

The information processing device 101 acquires the hash value of the image data of the normal cursor C1 and the hash value of the image data of the cursor C2 so as to determine that an image of the cursor is changed on the position P2 for the visual effect. Accordingly, the information processing device 101 selects the position P2 from coordinate positions in the search range and corrects the coordinate position of the cursor to the position P1. Thus, the information processing device 101 facilitates a touch operation with respect to a narrow region which is difficult to be designated by a finger. The system 100 according to the first embodiment is described below with reference to FIGS. 2 to 14.

### First Embodiment

(System Configuration Example of Thin Client System)

A case in which the system 100 depicted in FIG. 1 is applied to a thin client system is now described.

FIG. 2 illustrates a system configuration example of a thin client system. In FIG. 2, a thin client system 200 includes a server 201 and a plurality of client devices 202 (three client devices in the example of FIG. 2). In the thin client system 200, the server 201 and the client devices 202 are connected with each other via a network 210 in a communicable manner. The network 210 is a mobile communication network (mobile telephone network) or Internet, for example.

The thin client system 200 allows the server 201 to remotely control screens which are displayed by the client devices 202. According to the thin client system 200, the client devices 202 are allowed to display a result of processing which is executed by the server 201 or data which is held by the server 201, in practice. Accordingly, in the thin client system 200, it is seemed that the client devices 202 are capable of executing processing or holding data independently.

The server 201 is a computer which provides a remote screen control service for remotely controlling a screen which is displayed in the client devices 202. The server 201 corresponds to the information processing device 101 depicted in FIG. 1. The client devices 202 are computers which receive provision of the remote screen control service from the server 201. The client devices 202 correspond to the terminal device 102 depicted in FIG. 1.

(Hardware Configuration Example of Server 201)

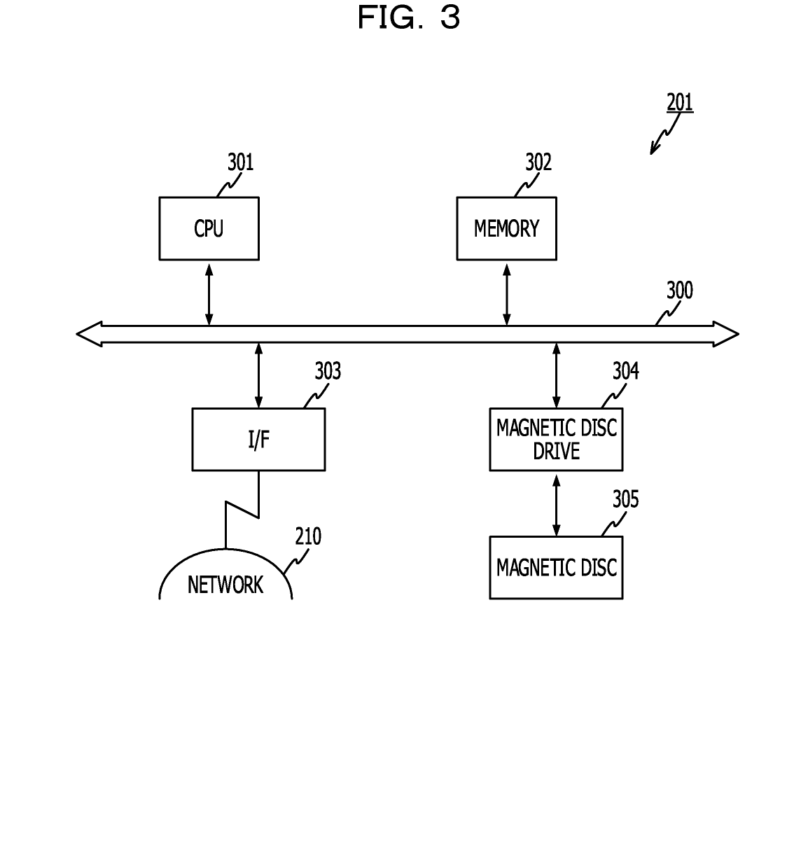

FIG. 3 is a block diagram illustrating a hardware configuration example of the server. In FIG. 3, the server 201 includes a central processing unit (CPU) 301, a memory 302, an interface (I/F) 303, a magnetic disc drive 304, and a magnetic disc 305. Further, respective elements are connected with each other via a bus 300.

Here, the CPU 301 controls the whole of the server 201. The memory 302 includes a read only memory (ROM), a random access memory (RAM), a flash ROM, and the like, for example. Specifically, the flash ROM and the ROM store various programs and the RAM is used as a work area of the CPU 301. Programs stored in the memory 302 are loaded on the CPU 301, thus allowing the CPU 301 to execute coded processing.

The I/F 303 is connected with the network 210 through a communication line so as to be coupled with other computers (for example, the client devices 202) via the network 210. Further, the I/F 303 serves as an interface between the network 210 and the inside and controls input/output of data from other computers. A modem, a LAN adapter, or the like may be employed as the I/F 303, for example.

The magnetic disc drive 304 controls data reading/writing with respect to the magnetic disc 305 in accordance with the control of the CPU 301. The magnetic disc 305 stores data which is written in the control of the magnetic disc drive 304. Here, the server 201 may include a solid state drive (SSD), a keyboard, a display, and the like, for example, as well as the above-described constituent elements.

(Hardware Configuration Example of Client Device 202)

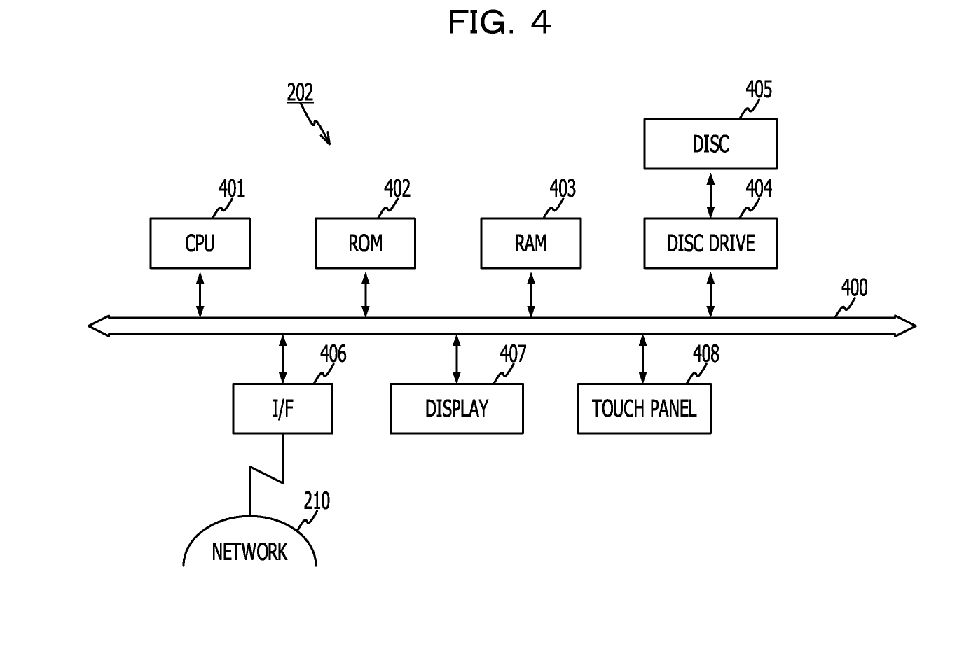

FIG. 4 is a block diagram illustrating a hardware configuration example of a client device. In FIG. 4, the client device 202 includes a CPU 401, a ROM 402, a RAM 403, a disc drive 404, a disc 405, an I/F 406, a display 407, and a touch panel 408. Further, respective elements are connected with each other via a bus 400.

The CPU 401 controls the whole of the client device 202. The ROM 402 stores programs such as a boot program. The RAM 403 is used as a work area of the CPU 401. The disc drive 404 controls data reading/writing with respect to the disc 405 in accordance with the control of the CPU 401. The disc 405 stores data which is written in the control of the disc drive 404. As the disc drive 404, a magnetic disc drive, a solid state drive, or the like, for example, may be employed. When the disc drive 404 is a magnetic disc drive, for example, a magnetic disc may be employed as the disc 405. Further, when the disc drive 404 is a solid state drive, a semiconductor element memory may be employed as the disc 405.

The I/F 406 is connected with the network 210 through a communication line so as to be coupled with other computers via the network 210. Further, the I/F 406 serves as an interface between the network 210 and the inside so as to control input/output of data from other computers.

The display 407 displays a cursor, an icon, a tool box, and data such as a document, an image, and function information. As the display 407, a thin film transistor (TFT) liquid crystal display, for example, may be employed. The display 407 includes the display screen 110 depicted in FIG. 1, for example.

The touch panel 408 detects a touch operation and a drag operation performed by a user. Here, it is assumed that the client device 202 depicted in FIG. 4 is a tablet terminal. When the client device 202 is a personal computer, the client device 202 may include a keyboard, a mouse, and the like.

(Functional Configuration Example of Server 201)

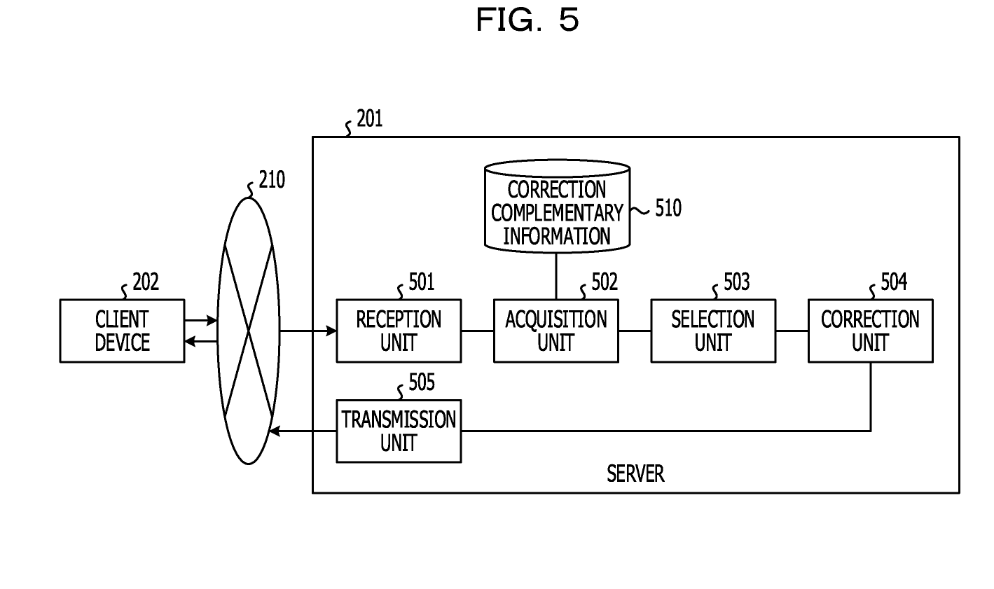

FIG. 5 is a block diagram illustrating a functional configuration example of a server according to the first embodiment. In FIG. 5, the server 201 includes a reception unit 501, an acquisition unit 502, a selection unit 503, a correction unit 504, and a transmission unit 505. Functions of the reception unit 501, the acquisition unit 502, the selection unit 503, the correction unit 504, and the transmission unit 505 which are control units are realized when the CPU 301 executes programs which are stored in a storage device. Specifically, the storage device is the memory 302 and the magnetic disc 305, which are depicted in FIG. 3, for example.

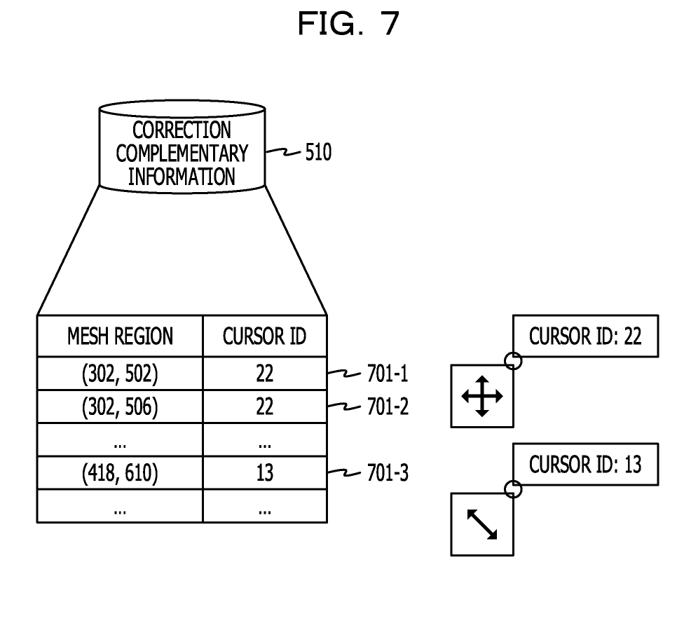

Further, the server 201 is accessible to correction complementary information 510. The correction complementary information 510 stores information for specifying an image of a cursor for each of regions which are obtained by dividing a search range. Storage contents of the correction complementary information 510 will be described with reference to FIG. 7.

The reception unit 501 receives operation information of an operation which is performed on a screen of the client device 202. For example, the reception unit 501 receives operation information indicating operation input of a drag operation, a flick operation, a pinch-out operation, a pinch-in operation, and the like. The received operation information is stored in a storage device such as the memory 302 and the magnetic disc 305.

When operation information is received by the reception unit 501, the acquisition unit 502 acquires image information of an update region, which is updated in a case in which an operation position is set to each coordinate position, of a screen, for every coordinate position of a plurality of coordinate positions in the search range from the operation position which is specified on the basis of the operation information. For example, the acquisition unit 502 issues a cursor movement instruction for moving a cursor to a certain coordinate position in a search range with respect to an OS and acquires image information which is updated through mouse over processing performed by an application due to the movement of the cursor.

Further, when operation information is received, the acquisition unit 502 may acquire image information of a cursor which is included in an update region, which is updated in a case in which a coordinate position of a cursor indicating an operation position is set to each coordinate position, of a screen, for every coordinate position. Here, acquired image information is stored in a storage region such as the correction complementary information 510.

The selection unit 503 selects any coordinate position from a plurality of coordinate positions on the basis of image information of an update region which is acquired for each of the coordinate positions. For example, the selection unit 503 selects a coordinate position on which image information is changed.

Further, the selection unit 503 may select any coordinate position from a plurality of coordinate positions on the basis of the number of coordinate positions on which contents of acquired image information of a cursor are same as each other among a plurality of coordinate positions. Further, the selection unit 503 may select any coordinate position from coordinate positions, on which contents of acquired image information of a cursor are same as each other and whose number is smallest, among a plurality of coordinate positions.

For example, it is assumed that there is one coordinate position on which image information of a normal cursor is obtained, there are 10 coordinate positions on which image information of a cursor indicating that it is possible to perform a vertical drag operation is obtained, and there are three coordinate positions on which image information of a cursor indicating that it is possible to perform a horizontal drag operation is obtained. In this case, the selection unit 503 selects any coordinate position among coordinate positions, on which image information of a cursor indicating that it is possible to perform a horizontal drag operation is obtained, and of which the number is the smallest, other than the image information of a normal cursor. Further, the selection unit 503 may select a coordinate position which is closest to an operation position, among coordinate positions on which image information of a cursor indicating that it is possible to perform a horizontal drag operation is obtained.

Further, the selection unit 503 may select any coordinate position from coordinate positions on which a first line and a second line intersect with each other. The first line is a line which is formed by connecting coordinate positions of a first coordinate position group in which pieces of image information of a cursor acquired by the acquisition unit 502 have same contents as each other, among a plurality of coordinate positions. The second line is a line which is formed by connecting coordinate positions of a second coordinate position group in which pieces of image information of a cursor acquired by the acquisition unit 502 have same contents as each other. Here, the selected coordinate position is stored in a storage device such as the memory 302 and the magnetic disc 305.

The correction unit 504 corrects an operation position to any coordinate position selected by the selection unit 503. For example, the correction unit 504 issues a cursor movement instruction to an OS for a coordinate position.

The transmission unit 505 transmits updated image information of a frame buffer to the client device 202. The frame buffer is a storage region in which image data for one frame which is to be displayed on the display screen 110 is temporarily stored and is a video RAM (VRAM), for example. The frame buffer is realized by a storage device such as the memory 302 and the magnetic disc 305, for example.

(Functional Configuration Example of Client Device 202)

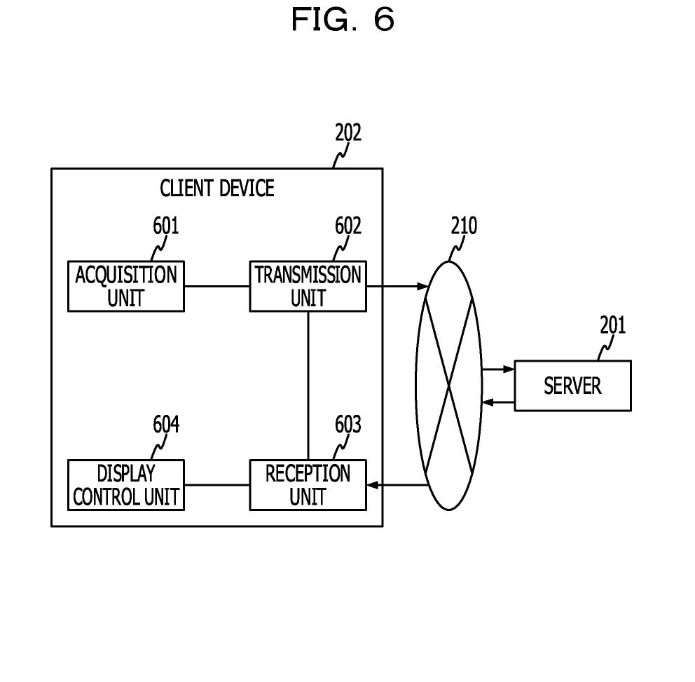

FIG. 6 is a block diagram illustrating a function configuration example of a client device. In FIG. 6, the client device 202 includes an acquisition unit 601, a transmission unit 602, a reception unit 603, and a display control unit 604. The acquisition unit 601, the transmission unit 602, the reception unit 603, and the display control unit 604 are functions serving as control units. Specifically, functions of the acquisition unit 601, the transmission unit 602, the reception unit 603, and the display control unit 604 are realized by allowing the CPU 401 to execute programs which are stored in a storage device such as the ROM 402, the RAM 403, and the disc 405 or by the I/F 406 depicted in FIG. 4. Processing results of respective function units are stored in a storage device such as the RAM 403 and the disc 405.

The acquisition unit 601 acquires operation information indicating operation input of a user. Specifically, the acquisition unit 601 receives operation input of a user performed by using the touch panel 408 on the display screen, so as to acquire operation information indicating the operation input of the user, for example. The acquisition unit 601 receives operation information indicating operation input of a touch operation, a drag operation, a flick operation, a pinch-out operation, a pinch-in operation, and the like, by using the touch panel 408, for example. Further, the acquisition unit 601 may acquire operation information which is converted to be operation information employing operation input with a mouse and is interpretable by an application running in the server 201. Here, conversion processing of operation information may be performed on the server 201 side. There is a case where operation input is continuously performed as a drag operation. In this case, the acquisition unit 601 may acquire operation information indicating operation input of a user at fixed time intervals.

The transmission unit 602 transmits operation information acquired by the acquisition unit 601 to the server 201. For example, when operation information is acquired by the acquisition unit 601, the transmission unit 602 transmits the acquired operation information to the server 201 for every acquisition.

The reception unit 603 receives updated image information from the server 201. For example, the reception unit 603 receives image information which is updated by an application running in the server 201 from the server 201. The display control unit 604 controls the display 407 so as to display updated image information which is received by the reception unit 603.

FIG. 7 illustrates an example of a storage content of correction complementary information. The correction complementary information 510 stores information for specifying an image of a cursor for every mesh region. The correction complementary information 510 depicted in FIG. 7 includes records 701-1 to 701-3.

The correction complementary information 510 includes two fields which are a mesh region and a cursor ID. In the mesh region field, information for uniquely specifying a mesh region is stored. Information for uniquely specifying a mesh region is a coordinate position of each vertex of a mesh region, for example. When the mesh region is a rectangular region, information for uniquely specifying a mesh region may be a coordinate position of an upper-left vertex and a coordinate position of a lower-right vertex. Further, when the mesh region is a rectangular region and a range of the mesh region is invariable, information for uniquely specifying a mesh region may be a coordinate position of a center of the mesh region. In the first embodiment, a coordinate position of a center of a mesh region is stored in the mesh region field under the assumption that a mesh region is a rectangular region and a range of the mesh region is height 4 pixels×width 4 pixels.

In the cursor ID field, information for specifying an image of a cursor in a corresponding mesh region is stored. Information for specifying an image of a cursor may be a hash value, which is obtained by using a hash function, of an image of a cursor, for example. In a case where it is possible for software which executes this correction processing to acquire an ID of a cursor image which is an argument of an API for changing a cursor when a cursor is changed, information for specifying an image of a cursor may be an ID of a cursor image. In the example of FIG. 7, cursor ID:22 and cursor ID:13 are illustrated as examples.

For example, the record 701-1 indicates that a cursor ID in a mesh region of which a coordinate position of the center is (302, 502) is “22”.

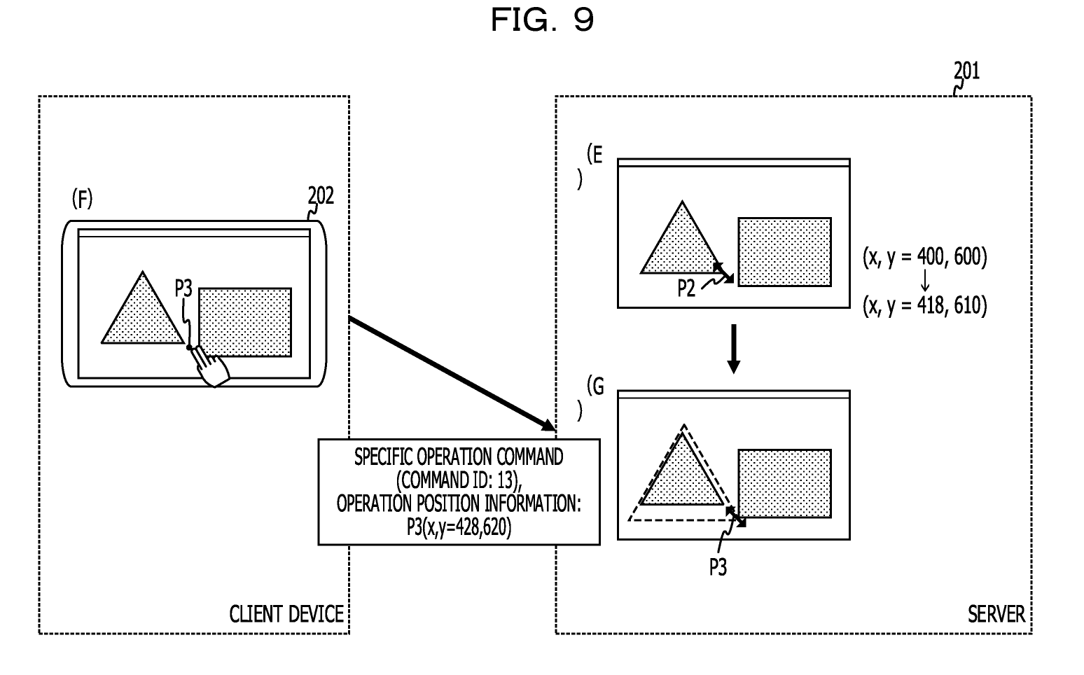

FIG. 8 is an explanatory diagram (I) illustrating an operation example of correction processing according to the first embodiment. FIG. 9 is an explanatory diagram (II) illustrating an operation example of the correction processing according to the first embodiment. The client device 202 depicted in FIG. 8 is in a state of displaying images of a triangle and a rectangle which are transmitted from the server 201. In this state, the client device 202 receives a specific operation from a user. The specific operation may be any operation as long as the operation is distinguishable from an operation which is performed in a normal user interface. For example, it is assumed that the specific operation of the first embodiment is an operation in which a screen is started to be traced by two fingers.

Further, a device which recognizes a specific operation may be the client device 202 or the server 201. For example, in a case where the client device 202 recognizes an operation as a specific operation, when the client device 202 receives an operation for starting tracing a screen by two fingers, the client device 202 transmits an operation class indicating a specific operation and a coordinate position of a midpoint of points, on which the two fingers touch the touch panel, as operation position information to the server 201. Further, when the client device 202 recognizes an operation as a specific operation, the client device 202 transmits coordinate positions of points on which the two fingers touch the touch panel. When the server 201 receives the coordinate positions of two points, the client device 202 recognizes the operation as a specific operation.

In the description of FIGS. 8 and 9, it is assumed that the client device 202 recognizes an operation as a specific operation. As depicted in part (A) of FIG. 8, the client device 202 transmits a command ID:13 indicating a specific operation and point information P1 (x,y=400,600) as operation position information to the server 201. Here, x in the point information denotes a transverse coordinate position on a point on the display screen 110. y in the point information denotes a longitudinal coordinate position on the point on the display screen 110.

After receiving the command ID indicating a specific operation and the operation position information, the server 201 calculates a search range in which a cursor movement instruction is executed, as depicted in part (B) of FIG. 8. The search range is a range in which correction of a coordinate position of a cursor is performed. For example, the server 201 calculates a search range which is obtained by expanding a region around the coordinate position of the operation position information by 100 pixels in longitudinal and lateral directions as a threshold value.

In the example of FIG. 8, the server 201 calculates a search range B1 (x,y,w,h=300,500,200,200) based on (x,y=400,600) as a center. Here, x in the search range denotes a transverse coordinate position on an upper-left point of the search range on the display screen 110. y in the search range denotes a longitudinal coordinate position on an upper-left point of the search range on the display screen 110. w in the search range denotes the number of pixels of a width of a transverse direction of the search range on the display screen 110. h in the search range denotes the number of pixels of a height of a longitudinal direction of the search range on the display screen 110.

Further, a threshold value may be designated by an administrator of the thin client system 200. Alternatively, when the client device 202 starts using the thin client system 200, the client device 202 may transmit a range in which fingers of a user touch the display screen to the server 201 and the server 201 may set the touched range as a threshold value.

After calculation of the search range, the server 201 executes the cursor movement instruction for every mesh region obtained by dividing a search range so as to acquire an image of the cursor, as depicted in part (C) in FIG. 8. After acquisition of the image of the cursor, the server 201 acquires a unique value, which is obtained by subjecting the image of the cursor to a hash function, as a cursor ID and adds the mesh region and the cursor ID to the correction complementary information 510. For example, in part (C) of FIG. 8, the record 701-1 indicates a cursor ID in a mesh region R1, the record 701-2 indicates a cursor ID in a mesh region R2, and the record 701-3 indicates a cursor ID in a mesh region R3.

After acquisition of a cursor ID of each mesh region, the server 201 calculates a sum of the number of appearances of an identical cursor ID for each cursor ID in the search region B1 as depicted in part (D) of FIG. 8, so as to select a mesh region with a cursor ID whose calculated sum of appearances is smallest. In the example of part (D) of FIG. 8, the server 201 selects a mesh region (x,y=418,610) in the mesh region R3 of a cursor ID:13 whose calculated sum of appearances is smallest. Here, the server 201 may exclude a cursor ID indicating a default cursor from selection objects in the selection. The server 201 performs processing depicted in part (E) of FIG. 9.

After the selection of a mesh region, the server 201 corrects the operation position information P1 (x,y=400,600) which is received in part (A) of FIG. 8 to operation position information P2 (x,y=418,610) by using a central point of the selected mesh region, as depicted in part (E) of FIG. 9. The server 201 notifies an OS to set a coordinate position of a cursor to the operation position information P2 and starts a drag operation. Further, the server 201 transmits image information of an image on which the drag operation is started to the client device 202.

Subsequently, it is assumed that a user continues to perform a specific operation as depicted in part (F) of FIG. 9. In part (F) of FIG. 9, it is assumed that the user performs the drag operation in the lower-right direction. In this case, the client device 202 transmits a command ID:13 indicating a specific operation and point information P3 (x,y=428,620) as operation position information to the server 201.

When receiving a command ID indicating a second or later specific operation and operation position information, the server 201 does not recognize the received operation as a specific operation but recognizes the received operation as a rest of a normal drag operation and converts the command ID indicating a specific operation into an ID indicating the drag operation, thus continuing the operation, as depicted in part (G) of FIG. 9. Consequently, the server 201 executes an enlargement operation of a triangle in response to the drag operation.

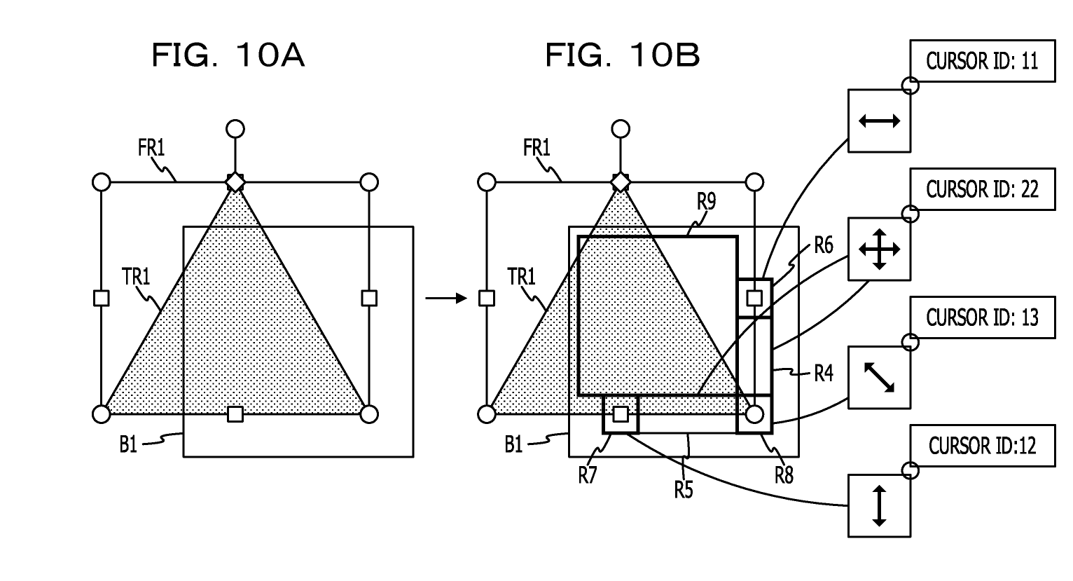

In part (D) of FIG. 8, the server 201 selects a mesh region of a cursor ID whose calculated sum of appearances is smallest. However, there are cases in which there are a plurality of mesh regions of the cursor ID whose calculated sum of appearances is smallest and a case in which there are a plurality of cursor IDs whose calculated sum of appearances is smallest. In these cases, the server 201 may select a mesh region which is to be a correction region by using edge detection. An example of selection of a cursor ID performed by using edge detection is described with reference to FIGS. 10A and 10B.

FIGS. 10A and 10B illustrate a selecting example of a cursor ID in which edge detection is used. Specifically, FIGS. 10A and 10B illustrate an example in which corner detection is performed by using an arrangement of cursors in a search range and a cursor ID of a mesh region with which an edge intersects is selected. Further, a mesh region with the smallest cursor ID is referred to as a “correction candidate region” and a coordinate position of a center of the correction candidate region is referred to as a “coordinate position of a correction candidate”.

The corner detection is a type of the edge detection and is processing for detecting a part on which colors of adjacent pixels in an image become discontinuous and with which an edge intersects. For the corner detection, a detection method by a Harris operator may be used, for example. Specifically, the server 201 converts a cursor ID of a mesh region into image information so as to use the image information for the corner detection.

The server 201 considers each mesh region as one pixel and converts a cursor ID associated with the mesh region into color information. As an example in which a cursor ID is converted into color information, the server 201 sorts cursor IDs in an ascending order of calculated sums of cursor IDs and calculates a proportion of each cursor ID in the whole of the mesh regions in a search range, for every cursor ID. Subsequently, the server 201 imparts color information based on the proportion to a cursor ID. Color information is calculated by a formula which is “(256/100)×percentage occupied by cursor ID”, for example. The server 201 imparts color information such that the server 201 imparts 2.56×2=5.12≈5 to a cursor ID occupying 2% of the total, imparts 77 to a cursor ID occupying 30% of the total in a similar manner, . . . . It is assumed that the imparted color information is an 8-bit grayscale. By imparting different color information on the basis of a proportion of a cursor ID to the total, the server 201 is capable of easily detecting a border on which mouse cursor IDs differ.

Subsequently, the server 201 passes the converted image information to corner detection processing using the Harris operator so as to acquire a coordinate position of a pixel which is to be a corner. Hereinafter, a coordinate position of a pixel which is to be a corner is referred to as a “corner position”.

After acquiring a corner position, the server 201 converts the corner position into an original coordinate position of a mesh region. In the embodiment, the server 201 is capable of calculating a coordinate position of a mesh region corresponding to a corner position, by adding a value (4x,4y) which is obtained by quadruplicating a value of the corner position to an upper-left coordinate (x,y) of the mesh region.

Subsequently, the server 201 determines whether or not a distance between the corner position and a touched operation position is shorter than “a distance with respect to a coordinate position of another closest correction candidate×a threshold value”. The threshold value is 2, for example. The above-mentioned determination processing is performed for distinguishing a case in which a user operates a corner from a case in which a corner position is detected even when an operation is performed without any intention to operate a corner.

When a distance between a corner position and an operation position is shorter than “a distance between the corner position and a coordinate position of another closest correction candidate×a threshold value”, the server 201 selects a coordinate position of a center of a mesh region corresponding to the corner position, as a correction coordinate and performs correction. On the other hand, when a distance between a corner position and an operation position is equal to or longer than “a distance between the corner position and a coordinate position of another closest correction candidate×a threshold value”, the server 201 selects a coordinate position of another closest correction candidate, as a correction coordinate and performs correction.

In the edge detection described thus far, an application on a server performs detection by using a property in which an interface and a window have a rectangular shape. For example, FIG. 10A illustrates a state in which a frame FR1 of which a shape is changed through a drag operation is provided to a triangle TR1. After receiving a specific operation from a user in this state, the server 201 calculates a search range B1 and acquires a cursor ID for every mesh region in the search range B1. FIG. 10B illustrates a cursor ID of each mesh region as a result of acquisition of the cursor ID. Specifically, FIG. 10B illustrates a cursor ID:22 associated with a mesh region group R4 and R5, a cursor ID:11 associated with a mesh region R6, a cursor ID:12 associated with a mesh region R7, and a cursor ID:13 associated with a mesh region R8. Further, FIG. 10B illustrates a mesh region group R9 of which a cursor ID is not changed.

An example of edge detection performed by the server 201 is illustrated with reference to FIG. 10B. The server 201 generates image data obtained by mapping a cursor ID to a symbol of the 8-bit grayscale. It is assumed that a proportion of each mesh region in a group of R6, R7, and R8 to the total is 2%, a proportion of each mesh region in a group of R4 and R5 to the total is 10%, and a proportion of each mesh region in a group of R9 to the total is 50%. In this case, the server 201 imparts color information of 5 to respective mesh regions which belong to the group of R6, R7, and R8, imparts color information of 26 to respective mesh regions which belong to the group of R4 and R5, and imparts color information of 128 to respective mesh regions of R9. Subsequently, the server 201 passes image information which is generated by imparting color information to mesh regions, to the corner detection processing using the Harris operator so as to acquire a corner position. When the acquired corner position is (x,y=100,200), the server 201 quadruplicates the corner position to obtain (x,y=400,800) and calculates a position on an original coordinate of a mesh region. Subsequently, the server 201 compares a “distance between the corner position and an operation position” with “a distance between a coordinate of another closest correction candidate and the operation position×a threshold value (2)”. For example, when the distance between the corner position and the operation position is 30 pixels and the corner position is distant from another closest correction candidate by 20 pixels, the server 201 performs correction based on the corner position as a correction coordinate due to 30<20×2. When the corner position is distant from the closest correction candidate only by 10 pixels, the server 201 selects the correction candidate as a correction coordinate and performs correction.

As a result, in FIG. 10B, the server 201 detects the mesh region group R4 and R5 as edges by corner detection and selects the mesh region R5 which is on an intersection of the mesh region group R4 and R5 as a correction region. Accordingly, the server 201 is capable of properly calculating a correction coordinate in more cases, by using the correction complementary information 510.

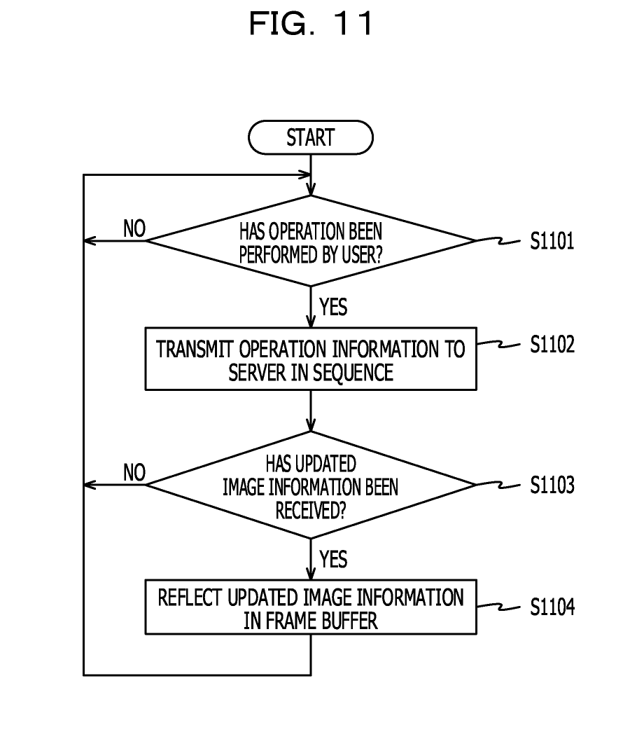

Subsequently, flowcharts for performing operations which have been described with reference to FIG. 8 to FIGS. 10A and 10B are described with reference to FIGS. 11 to 14.

FIG. 11 is a flowchart illustrating an example of a drawing processing procedure performed by a client device. The drawing processing performed by a client device is a processing for drawing image information received from the server 201. The client device 202 determines whether or not an operation has been performed by a user (step S1101). When no operation has been performed by a user (step S1101: No), the client device 202 executes processing of step S1101 after elapse of a certain period of time. When an operation has been performed by a user (step S1101: Yes), the client device 202 transmits operation information to the server 201 in sequence (step S1102). Subsequently, the client device 202 determines whether or not to have received updated image information from the server 201 (step S1103). When the client device 202 has received no updated image information (step S1103: No), the client device 202 transits to the processing of step S1101.

When the client device 202 has received updated image information (step S1103: Yes), the client device 202 reflects the updated image information in a frame buffer (step S1104). After an end of execution of step S1104, the client device 202 executes the processing of step S1101. Thus, the drawing processing is executed by the client device. Accordingly, the client device 202 is capable of drawing image information updated in the server 201 and providing the image information in which an operation is reflected.

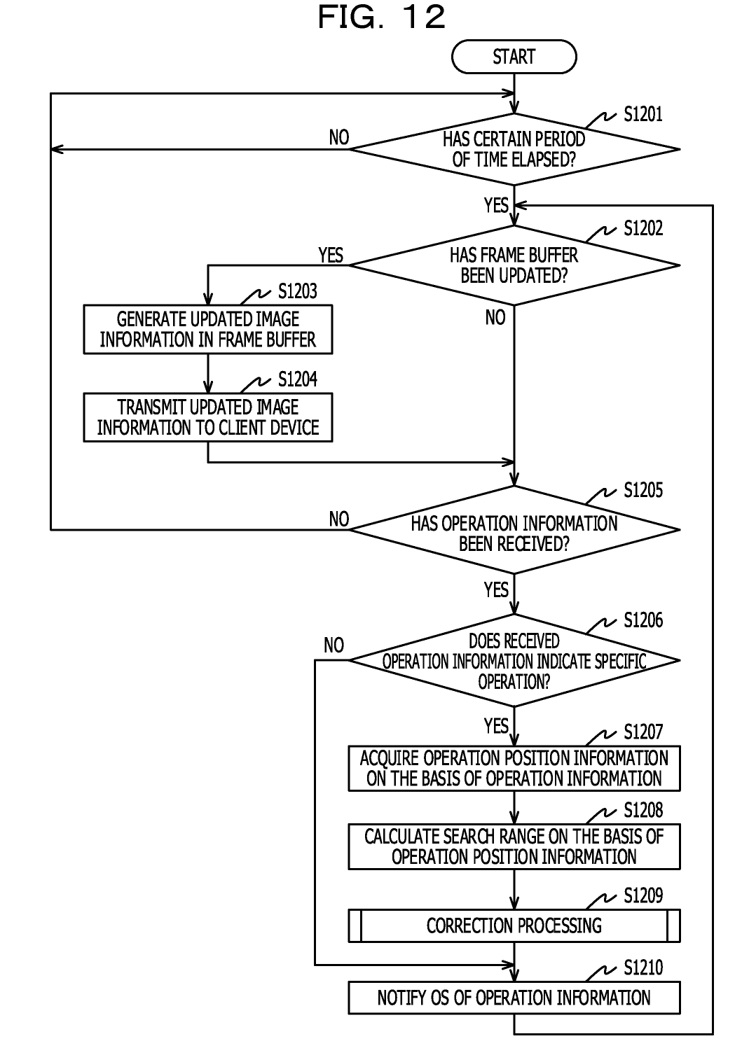

FIG. 12 is a flowchart illustrating an example of a drawing processing procedure performed by a server. The drawing processing performed by a server is processing for generating image information in which operation information from the client device 202 is reflected and transmitting the image information to the client device 202.

The server 201 determines whether or not a certain period of time has elapsed (step S1201). For example, when the server 201 updates a display screen by 30 frames per second (fps), the server 201 determines whether or not 0.033 milliseconds has elapsed as the certain period of time. When a certain period of time has not elapsed (step S1201: No), the server 201 executes processing of step S1201 after elapse of a certain period of time. When a certain period of time has elapsed (step S1201: Yes), the server 201 determines whether or not a frame buffer has been updated (step S1202). Here, data for comparison for update is data of a frame buffer of a certain period of time before.

When a frame buffer has been updated (step S1202: Yes), the server 201 generates updated image information in the frame buffer (step S1203). Subsequently, the server 201 transmits the updated image information to the client device 202 (step S1204). After an end of processing of step S1204, the server 201 transits to processing of step S1205.

When the frame buffer has not been updated (step S1202: No) or after the server 201 transmits the updated image information to the client device (step S1204), the server 201 determines whether or not to have received operation information from the client device 202 (step S1205). When the server 201 has not received operation information (step S1205: No), the server 201 transits to the processing of step S1201. When the server 201 has received operation information (step S1205: Yes), the server 201 subsequently determines whether or not the received operation information indicates a specific operation (step S1206). When the received operation information does not indicate a specific operation (step S1206: No), the server 201 notifies an OS of the received operation information (step S1210). The OS which receives the operation information notifies an application of the operation information.

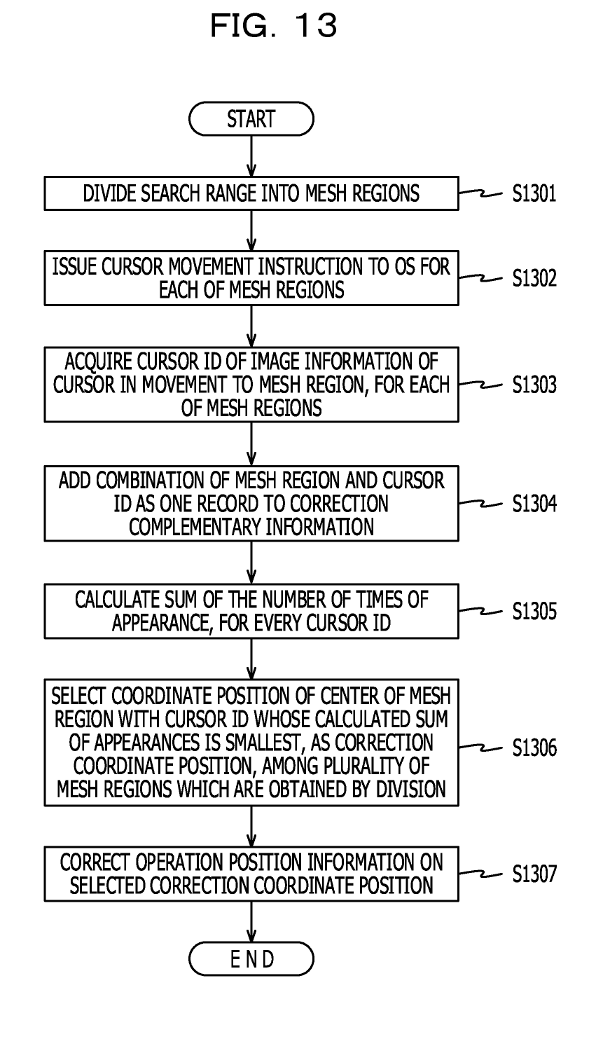

When the received operation information indicates a specific operation (step S1206: Yes), the server 201 acquires operation position information from the operation information (step S1207). Then, the server 201 calculates a search range on the basis of the operation position information (step S1208). Subsequently, the server 201 executes correction processing (steps S1209). The correction processing will be described in detail later with reference to FIG. 13. After an end of the execution of step S1209, the server 201 notifies the OS of the operation information (step S1210). The received operation information may be notified through the OS to an application and the frame buffer may be updated by the application, so that the processing transits to processing of step S1202. Thus, the drawing processing is executed by the server. Accordingly, the server 201 is capable of generating image information in which operation information from the client device 202 is reflected and transmitting the image information to the client device 202.

FIG. 13 is a flowchart illustrating an example of a correction processing procedure according to the first embodiment. The correction processing is processing for correcting a coordinate position of a cursor. The server 201 divides a search range into mesh regions (step S1301). Then, the server 201 issues a cursor movement instruction to an OS for each of the mesh regions (step S1302). Subsequently, the server 201 acquires a cursor ID of image information of a cursor when the cursor moves to a mesh region, for every mesh region (step S1303). Then, the server 201 adds a combination of a mesh region and a cursor ID as one record to the correction complementary information 510 (step S1304). Subsequently, the server 201 calculates a sum of the number of times of an appearance for each cursor ID (steps S1305).

Then, the server 201 selects a coordinate position of a center of a mesh region of a cursor ID whose calculated sum of appearances is smallest, as a correction coordinate position, among a plurality of mesh regions obtained by the division (step S1306). Subsequently, the server 201 corrects operation position information on the selected correction coordinate position (step S1307). After an end of processing of step S1307, the server 201 ends the correction processing. By executing the correction processing, the server 201 is capable of correcting a coordinate position of a cursor to an appropriate position which is expected by a user.

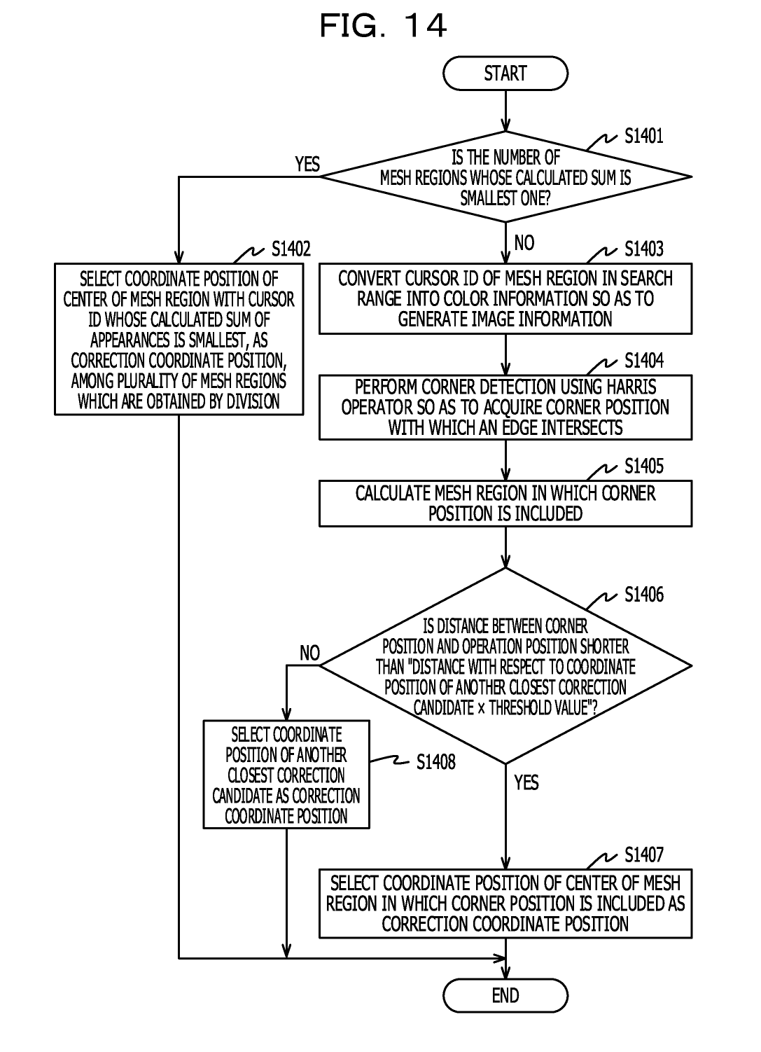

FIG. 14 is a flowchart illustrating an example of a procedure of processing for selecting a mesh region by using edge detection in the processing of step S1306. The server 201 determines whether or not the number of mesh regions whose calculated sum is smallest is one (step S1401). When the number of mesh regions whose calculated sum is smallest is one (step S1401: Yes), the server 201 selects a coordinate position of a center of a mesh region with a cursor ID whose calculated sum of appearances is smallest, as a correction coordinate position, from a plurality of mesh regions obtained by the division (step S1402). After an end of processing of step S1402, the server 201 ends the flowchart depicted in FIG. 14.

When there are two or more mesh regions whose calculated sum is smallest (step S1401: No), the server 201 converts a cursor ID of a mesh region in the search range into color information so as to generate image information (step S1403). Then, the server 201 acquires a corner position with which an edge intersects, by performing corner detection using the Harris operator (step S1404). Subsequently, the server 201 calculates a mesh region in which a corner position is included (step S1405).

Subsequently, the server 201 determines whether or not a distance between the corner position and an operation position is smaller than “a distance with respect to a coordinate position of another closest correction candidate×a threshold value” (step S1406). When a distance between the corner position and an operation position is smaller than “a distance with respect to a coordinate position of another closest correction candidate×a threshold value” (step S1406: Yes), the server 201 selects a coordinate position of a center of the mesh region in which the corner position is included as a correction coordinate position (step S1407). When a distance between the corner position and an operation position is equal to or larger than “a distance with respect to a coordinate position of another closest correction candidate×a threshold value” (step S1406: No), the server 201 selects a coordinate position of another closest correction candidate as a correction coordinate position (step S1408). After an end of processing of step S1407 or step S1408, the server 201 ends the flowchart depicted in FIG. 14. Execution of the flowchart depicted in FIG. 14 enables proper calculation of a correction coordinate when there are a plurality of mesh regions whose calculated sum is smallest.

As described above, according to the server 201, a position of a touch operation which is performed on a screen of the terminal device 102 is corrected to a position on which display image is changed for a visual effect when a cursor is virtually moved around the position of the touch operation. Accordingly, the server 201 facilitates a touch operation to a narrow region which is difficult to be designated by a finger.

Further, according to the server 201, a coordinate position of a cursor may be corrected to a position on which an image of a cursor is changed for a visual effect when the cursor is virtually moved. A position on which an image of a cursor is changed for the visual effect indicates a position on which it is possible to perform some sort of processing through clicking by a mouse. Accordingly, the server 201 is capable of correcting an operation position of a touch operation which is deviated from a narrow region which is difficult to be designated by a finger, to a position on which some sort of processing is performed.

Further, according to the server 201, a coordinate position of a cursor may be corrected to a coordinate position on which images of a cursor have virtually same contents and whose number is smallest. A region which is formed by coordinate positions which have same contents as each other and whose number is smallest is the narrowest region in the search range. Accordingly, correction to a coordinate position in a group of coordinate positions, on which images of a cursor have virtually same contents and whose number is smallest, by the server 201 facilitates a touch operation to the narrowest region in a search range.

Further, according to the server 201, a coordinate position of a cursor may be corrected by using edge detection. Accordingly, the server 201 comes to be able to properly calculate a correction coordinate in more cases.

Further, according to the server 201, processing for acquiring image information of an update region may be started when a specific operation is received. Accordingly, the server 201 does not execute the processing for acquiring image information of an update region when a touch operation to a narrow region is not instructed, being able to reduce a load imposed on the server 201.

Further, the server 201 facilitates an operation to a fine region using a finger and is capable of suppressing an occurrence of an erroneous operation without increasing an operation amount of a user in a state independent from an instruction of an OS and an application.

### Second Embodiment

The server 201 according to the first embodiment acquires image information of a cursor so as to estimate a coordinate on which a user intends to touch. However, it may be preferable to receive an instruction of a user in practice. For example, there is a case in which a plurality of small buttons are arranged in a search range by an application. When a plurality of small buttons are arranged, it is possible to facilitate a touch operation to a plurality of small buttons by the first technique described with reference to FIG. 1. However, a coordinate position is changed by a fine motion of a finger in the first technique.

Therefore, such method that a server 201 according to the second embodiment receives an instruction of a user and corrects a coordinate position of a cursor in accordance with the instruction is described. Here, elements same as those described in the first embodiment are given the same reference characters and illustration and description thereof are omitted.

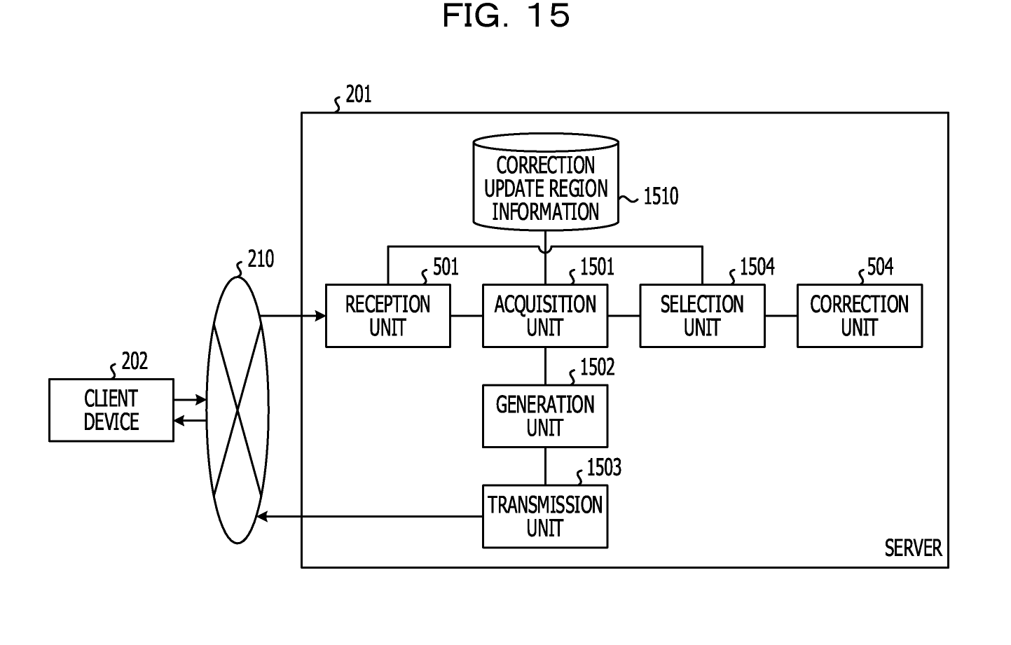

FIG. 15 is a block diagram illustrating a functional configuration example of a server according to the second embodiment. In FIG. 15, the server 201 includes a reception unit 501, an acquisition unit 1501, a generation unit 1502, a transmission unit 1503, a selection unit 1504, and a correction unit 504. Functions of the reception unit 501, the correction unit 504, the acquisition unit 1501, the generation unit 1502, the transmission unit 1503, and the selection unit 1504 which are control units are realized when the CPU 301 executes programs which are stored in a storage device. Specifically, the storage device is the memory 302 and the magnetic disc 305, which are depicted in FIG. 3, for example.

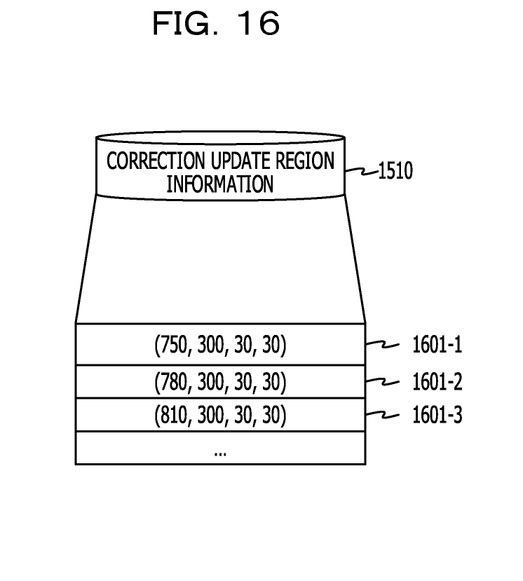

Further, the server 201 is accessible to correction update region information 1510. The correction update region information 1510 stores an update region which is updated by mouse over processing of a cursor. Storage contents of the correction update region information 1510 will be described with reference to FIG. 16.

When operation information is received by the reception unit 501, the acquisition unit 1501 acquires image information in a search range from an operation position of an updated screen which is updated when an operation position is set to each coordinate position, for every coordinate position. For example, the acquisition unit 1501 acquires image data in the search range based on an image format.

Further, when operation information is received by the reception unit 501, the acquisition unit 1501 may acquire image information before update of an update region of a screen which is updated when an operation position is set to each coordinate position, for every coordinate position. Here, the acquired image information is stored in a storage region such as the correction update region information 1510.

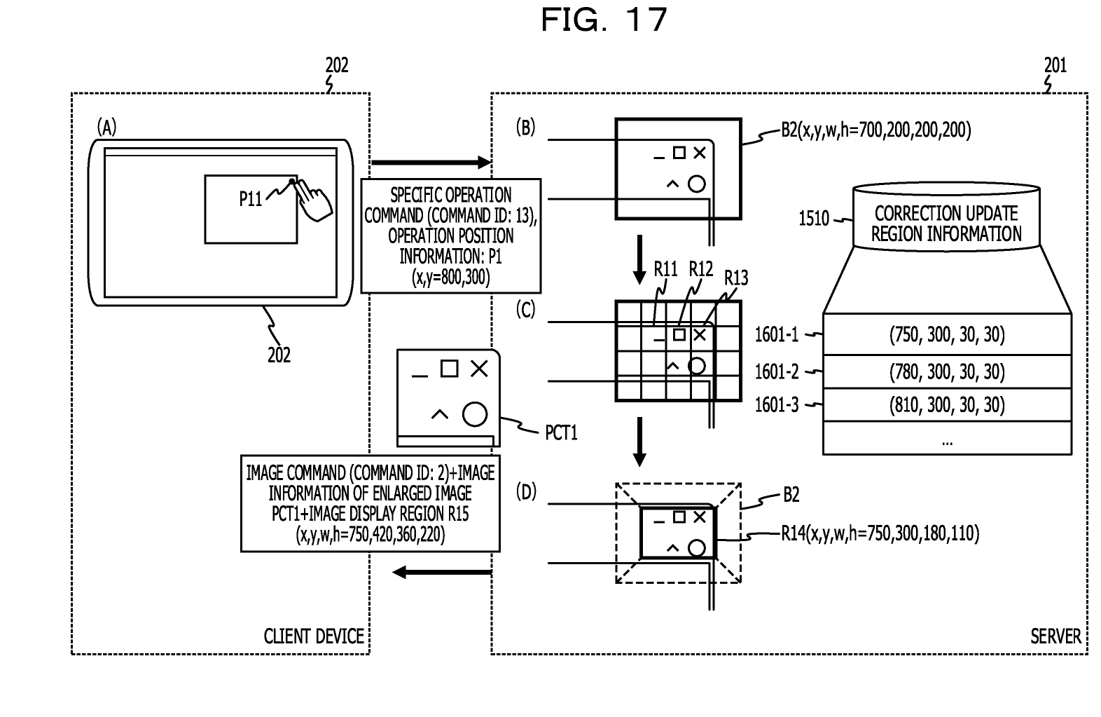

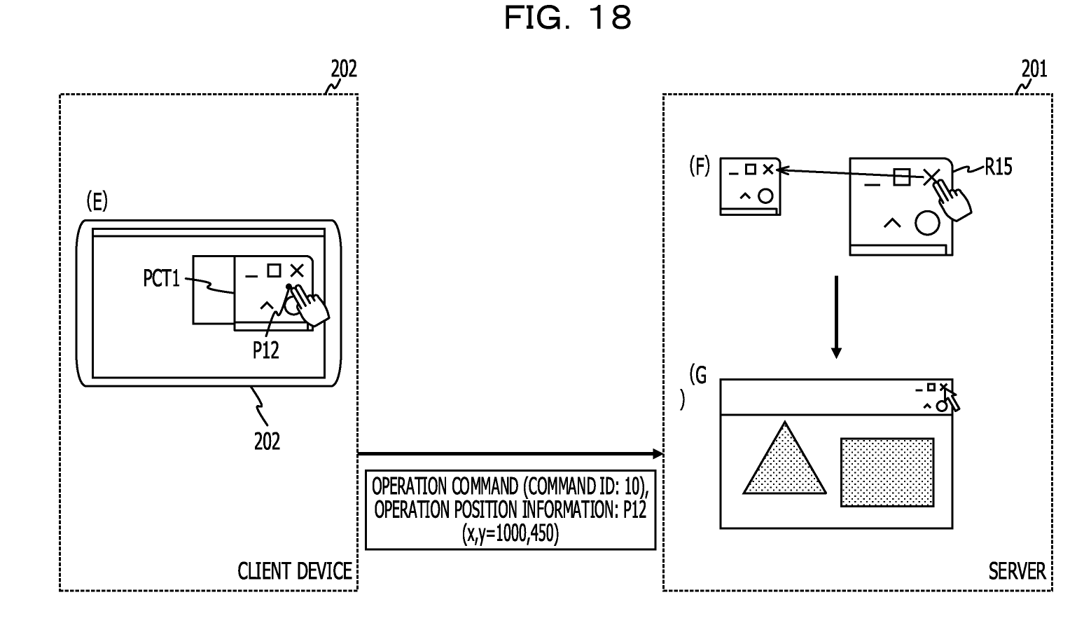

The generation unit 1502 generates image information of an enlarged image which is obtained by enlarging an image in the search range, on the basis of the image information, which is acquired by the acquisition unit 1501, in the search range. Further, the generation unit 1502 may generate image information of an enlarged image which is obtained by enlarging an image of an update region, on the basis of the image information, which is acquired for each coordinate position, of the update region. Further, the generation unit 1502 may generate image information of an enlarged image which is obtained by enlarging an image before update of an update region, on the basis of the image information before update, which is acquired for each coordinate position, of the update region. A specific method for enlarging an image will be described with reference to FIGS. 17 and 18. Here, generated image information of an enlarged image is stored in a storage device such as the memory 302 and the magnetic disc 305. The transmission unit 1503 transmits the image information, which is generated by the generation unit 1502, of the enlarged image to the client device 202.

As a result of the transmission of the image information of the enlarged image to the client device 202, the selection unit 1504 selects any coordinate position from a plurality of coordinate positions on the basis of the above-mentioned operation information in the following cases. The following cases include a case in which operation information of an operation which is performed in a display region, on which an enlarged image is displayed in a screen, of the client device 202 is received. A specific selection method will be described later with reference to FIG. 18. Here, a selection result is stored in a storage device such as the memory 302 and the magnetic disc 305.

FIG. 16 illustrates an example of a storage content of a correction update region information. The correction update region information 1510 stores an update region which is updated by mouse over processing of a cursor. The correction update region information 1510 depicted in FIG. 16 stores records 1601-1 to 1601-3. For example, an x coordinate of an upper-left point is 750 pixels, a y coordinate of the upper-left point is 300 pixels, a width from the upper-left point is 30 pixels, and a height from the upper-left point is 30 pixels, in the record 1601-1.

FIG. 17 is an explanatory diagram (I) illustrating an operation example of correction processing according to the second embodiment. FIG. 18 is an explanatory diagram (II) illustrating an operation example of the correction processing according to the second embodiment. The client device 202 depicted in FIG. 17 is in a state of displaying images of a triangle and a rectangle which are transmitted from the server 201. In this state, the client device 202 receives a specific operation from a user. The specific operation may be any operation as long as the operation is distinguishable from an operation which is performed in a normal interface. For example, it is assumed that the specific operation of the second embodiment is an operation in which a screen is touched by two fingers. Further, the thin client system 200 which is capable of performing the correction processing of the first embodiment and the correction processing of the second embodiment is realizable by separating a specific operation which is a trigger of the correction processing. For example, a specific operation in the first embodiment may be an operation in which a screen is touched by two fingers and a specific operation in the second embodiment may be an operation in which a screen is touched by three fingers.

Further, as described in the first embodiment, a device which recognizes an operation as a specific operation may be the client device 202 or the server 201 in the second embodiment as well. In the description of FIGS. 17 and 18, it is assumed that the client device 202 recognizes an operation as a specific operation. As depicted in part (A) of FIG. 17, the client device 202 transmits a command ID:13 indicating a specific operation and point information P11 (x,y=800,300) as operation position information to the server 201.

After receiving the command ID indicating a specific operation and the operation position information, the server 201 calculates a search range in which a cursor movement instruction is executed, as depicted in part (B) of FIG. 17. The search range is a range in which correction of a coordinate position of a cursor is performed. For example, the server 201 calculates a search range which is obtained by expanding a region around the coordinate position of the operation position information by 100 pixels in longitudinal and lateral directions.

In the example of part (B) of FIG. 17, the server 201 calculates a search range B2 (x,y,w,h=700,200,200,200) based on (x,y=800,300) as a center. After the calculation of the search range, the server 201 executes a cursor movement instruction for each of mesh regions which are obtained by dividing the search range, so as to acquire image information of an update region which is updated by mouse over processing of a cursor. Subsequently, the server 201 adds a region of which image information is updated to the correction update region information 1510. For example, in part (C) of FIG. 17, the record 1601-1 indicates a region R11, the record 1601-2 indicates a region R12, and the record 1601-3 indicates a region R13.

Here, an update region which is updated by mouse over processing of a cursor which is moved to a certain mesh region may be larger than the certain mesh region. In this case, the server 201 does not have to issue a cursor movement instruction for mesh regions other than the certain mesh region which is included in the above-mentioned update region.

After acquiring image information of the update region corresponding to the mesh region, the server 201 acquires a coupled update region R14 which is obtained by coupling respective update regions, as depicted in part (D) of FIG. 17. The coupled update region R14 may be smaller than a search range. In part (D) of FIG. 17, the coupled update region R14 is (x,y,w,h=750,300,180,110). In part (D) of FIG. 17, the coupled update region R14 is smaller than the search range B2.

Subsequently, the server 201 generates image information of an enlarged image PCT1 which is obtained by enlarging an image of the coupled update region R14 by designated magnification. As a method for generating image information of the enlarged image PCT1, the server 201 employs a bicubic method, a nearest neighbor method, a bilinear method, or the like. The designated magnification is designated by a designer of the thin client system 200, for example. The designated magnification is designated as twice, for example.

Further, the server 201 may enlarge an image after update of the coupled update region R14 to generate the enlarged image PCT1 or may enlarge an image before update of the coupled update region R14 to generate the enlarged image PCT1. When an image after update of the coupled update region R14 is enlarged, the server 201 uses image information which is stored in a frame buffer. When an image before update of the coupled update region R14 is enlarged, the server 201 holds contents of a frame buffer before issuing a cursor movement instruction. Then, after acquisition of the coupled update region R14, the server 201 generates an enlarged image PCT1 by using the held contents of the frame buffer.

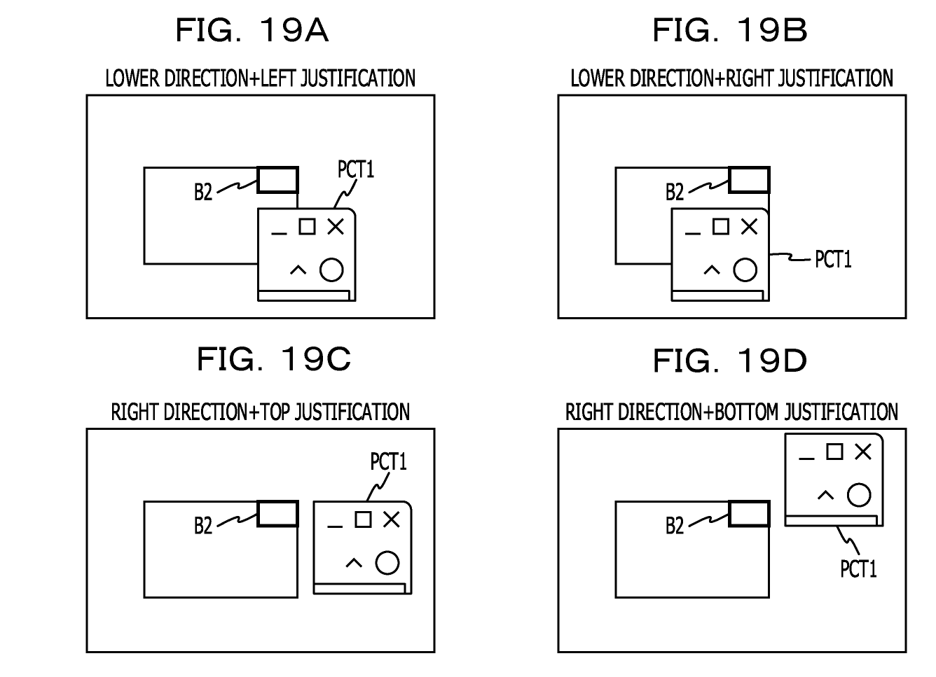

Then, the server 201 decides a display position of an enlarged image so that the display position does not overlap with the search range B2, and transmits image information of the enlarged image to the client device 202. An example in which a display region of an enlarged image is decided so that the display region does not overlap with the search range B2 will be described with reference to FIGS. 19A to 19D.

For example, the server 201 transmits a command ID:2 for transmitting an image, image information of the enlarged image PCT1, and an image display region R15 (x,y,w,h=750,420,360,220) which is to be a display position of the image information of the enlarged image PCT1, to the client device 202. Processing after the client device 202 receives the image information of the enlarged image will be described with reference to FIG. 18.

The client device 202 which has received the image information of the enlarged image PCT1 displays the enlarged image PCT1 in the image display region which is received with the image information of the enlarged image PCT1, as depicted in part (E) of FIG. 18. Subsequently, the client device 202 receives an operation performed by a user and transmits a command ID:10 indicating a normal operation and point information P12 (x,y=1000,450) as operation position information to the server 201.

After receiving the command ID indicating a normal operation and the operation position information, the server 201 calculates a coordinate position of a case in which the operation position information is applied to an actual screen when the operation position information is included in the image display region R15. Specifically, in the example of part (F) of FIG. 18, the server 201 determines whether or not the point information P12 (x,y=1000,450) which is the operation position information is included in the image display region R15 (x,y,w,h=750,420,360,220). In this example, the server 201 determines that the operation position information is included in the image display region R15.

Subsequently, the server 201 calculates a coordinate position of a case in which the operation position information is applied to original position information before enlargement. Specifically, the server 201 subtracts a (x,y) coordinate of the image display region R15 of the enlarged image from the operation position information. Then, the server 201 adds a (x,y) coordinate of the coupled update region R14 to a division result which is obtained by dividing the subtraction result by magnification of the enlarged image, thus calculating a coordinate position of a case in which the operation position information is applied to the original position information before enlargement. In the example of FIGS. 17 and 18, the server 201 calculates a coordinate position (x,y) of a case in which the operation position information is applied to the original position information before enlargement, as formula (1) below.

(x,y)=((1000−750)/2+750,(450−420)/2+300)=(875,315) (1)

After calculating a coordinate position of a case in which the operation position information is applied to the original position information before enlargement, the server 201 notifies an OS to set a coordinate position of a cursor to the calculated coordinate position. After the notification to the OS, the server 201 recognizes that a touch operation is performed on a corrected coordinate position and executes processing, as depicted in part (G) of FIG. 18.

Due to the operation described with reference to FIGS. 17 and 18, the thin client system 200 is capable of executing correction by obtaining an operation designated by a user, in a shorter procedure without an erroneous operation in an operation with respect to a fine region, even in a case in which it is difficult to perform correction of a coordinate position on a coordinate position of a cursor.

FIGS. 19A to 19D illustrate an example of a display position of image information of an enlarged image. The server 201 decides a display region of an enlarged image so that the display region does not overlap with an original search range. It is favorable that a display region of an enlarged image is closer from an original search range. Therefore, the server 201 decides a display region of an enlarged image so that the display region is close to the original search range. For example, the server 201 searches a region which does not overlap with the original search range in an order of a lower direction, a right direction, an upper direction, and a left direction of the original search range. In the description of FIGS. 19A to 19D, the description is provided on the assumption that an original search range is the search range B2 and an enlarged image is PCT1, by using the reference characters which are used in the description of FIGS. 17 and 18.

Hereinafter, the search range B2 and the enlarged image PCT1 are displayed with an interval of 10 pixels. Further, desk_w denotes the number of pixels of the width of the display screen 110 and desk_h denotes the number of pixels of the height of the display screen 110. Further, orig_x denotes x of the search range B2, orig_y denotes y of the search range B2, orig_w denotes w of the search range B2, and orig_h denotes h of the search range B2.

The information processing device 101 determines whether or not the enlarged image PCT1 is permitted to be displayed in the lower direction of the search range B2, on the basis of whether or not formula (2) below is satisfied.

desk_{—}h−(orig_{—}y+orig_{—}h)>orig_{—}h*designated magnification+10 (2)

Further, the information processing device 101 determines whether or not the enlarged image PCT1 is permitted to be displayed in the right direction of the search range B2, on the basis of whether or not formula (3) below is satisfied.

desk_{—}w−(orig_{—}x+orig_{—}w)>orig_{—}w*designated magnification+10 (3)

Further, the information processing device 101 determines whether or not the enlarged image PCT1 is permitted to be displayed in the upper direction of the search range B2, on the basis of whether or not formula (4) below is satisfied.

desk_{—}h−orig_{—}y>orig_{—}h*designated magnification+10 (4)

Further, the information processing device 101 determines whether or not the enlarged image PCT1 is permitted to be displayed in the left direction of the search range B2, on the basis of whether or not formula (5) below is satisfied.

desk_{—}w−orig_{—}x>orig_{—}w*designated magnification+10 (5)

Further, when the server 201 decides to display the enlarged image PCT1 in the lower direction or the upper direction of the search range B2 and formula (6) below is satisfied, the server 201 decides a display position of the enlarged image PCT1 so that the search range B2 and the enlarged image PCT1 are arranged in a left-justified manner. On the other hand, when formula (6) below is not satisfied, the server 201 decides a display position of the enlarged image PCT1 so that the search range B2 and the enlarged image PCT1 are arranged in a right-justified manner.

desk_{—}w−orig_{—}x>orig_{—}w*designated magnification+10 (6)

In a similar manner, when the server 201 decides to display the enlarged image PCT1 in the right direction or the left direction of the search range B2 and formula (7) below is satisfied, the server 201 decides a display position of the enlarged image PCT1 so that the search range B2 and the enlarged image PCT1 are arranged in a top-justified manner. On the other hand, when formula (7) below is not satisfied, the server 201 decides a display position of the enlarged image PCT1 so that the search range B2 and the enlarged image PCT1 are arranged in a bottom-justified manner.

desk_{—}h−orig_{—}y>orig_{—}h*designated magnification+10 (7)

FIGS. 19A to 19D illustrate an example in which the client device 202 displays the enlarged image PCT1 in accordance with a display position which is decided on the basis of a result which is obtained by executing formula (2) to formula (7) by the server 201. Specifically, FIG. 19A illustrates a display example of a case in which the server 201 decides to display the enlarged image PCT1 in a lower direction of the search range B2 in a left-justifying manner when formula (2) and formula (6) are satisfied. Further, FIG. 19B illustrates a display example of a case in which the server 201 decides to display the enlarged image PCT1 in a lower direction of the search range B2 in a right-justifying manner when formula (2) is satisfied and formula (6) is not satisfied.

Further, FIG. 19C illustrates a display example of a case in which the server 201 decides to display the enlarged image PCT1 in a right direction of the search range B2 in a top-justifying manner when formula (3) and formula (7) are satisfied. Further, FIG. 19D illustrates a display example of a case in which the server 201 decides to display the enlarged image PCT1 in a right direction of the search range B2 in a bottom-justifying manner when formula (3) is satisfied and formula (7) is not satisfied.

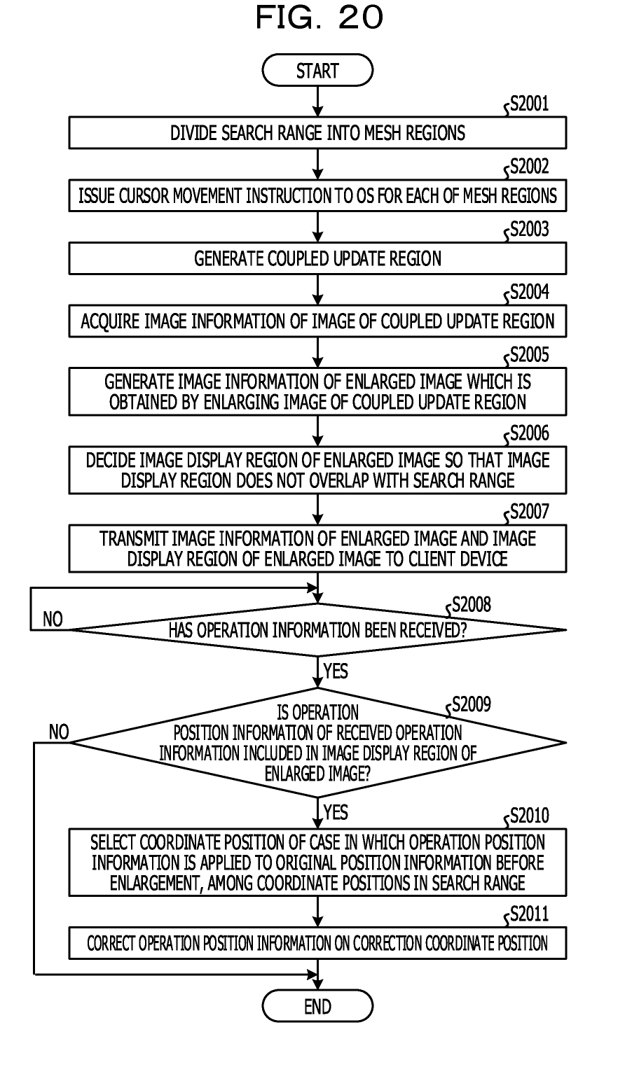

Subsequently, a flowchart for performing the operation which has been described with reference to FIGS. 17 to FIGS. 19A to 19D is described with reference to FIG. 20. Here, drawing processing performed by the client device according to the second embodiment is the same processing as the drawing processing performed by the client device according to the first embodiment, so that description thereof is omitted. The drawing processing performed by the server according to the second embodiment is the same processing as the drawing processing performed by the server according to the first embodiment except for correction processing which is performed in the drawing processing of the second embodiment, so that description of the drawing processing is omitted.

FIG. 20 is a flowchart illustrating an example of a correction processing procedure according to the second embodiment. The correction processing is processing for correcting a coordinate position of a cursor. Here, step S2001 and step S2002 are equivalent to step S1301 and step S1302, so that description thereof is omitted. After executing processing of step S2002, the server 201 generates a coupled update region which is obtained by coupling update regions (step S2003). Then, the server 201 acquires image information of an image of the coupled update region (step S2004). Subsequently, the server 201 generates image information of an enlarged image which is obtained by enlarging the image of the coupled update region (step S2005). Then, the server 201 decides an image display region of the enlarged image so that the image display region does not overlap with a search range (step S2006).

Subsequently, the server 201 transmits the image information of the enlarged image and the image display region of the enlarged image to the client device 202 (step S2007). Then, the server 201 determines whether or not to have received operation information (step S2008). When the server 201 has not received operation information (step S2008: No), the server 201 executes processing of step S2008 after a certain period of time elapses.

When the server 201 has received operation information (step S2008: Yes), the server 201 successively determines whether or not operation position information of the received operation information is included in the image display region of the enlarged image (step S2009). When the operation position information is not included in the image display region of the enlarged image (step S2009: No), the server 201 ends the correction processing.

When the operation position information is included in the image display region of the enlarged image (step S2009: Yes), the server 201 selects a coordinate position of a case in which the operation position information is applied to original position information before enlargement, among coordinate positions in the search range (step S2010). Subsequently, the server 201 corrects the operation position information on the correction coordinate position (step S2011). After an end of step S2011, the server 201 ends the correction processing. By executing the correction processing, the thin client system 200 is capable of executing correction of a coordinate position by obtaining an operation designating by a user, in a shorter procedure without an erroneous operation with respect to a fine region, even in a case in which it is difficult to perform correction of a coordinate position on a coordinate position of a cursor.

As described above, the server 201 according to the second embodiment transmits image information of a search range which includes a position of a touch operation performed on a screen of the client device 202 to the client device 202 and corrects a coordinate position of a cursor by using an operation position received after the transmission. Accordingly, the server 201 is capable of facilitating a touch operation with respect to a narrow region which is difficult to be designated by a finger.

Further, the server 201 may transmit image data of an update region which includes a position of a touch operation performed on a screen of the client device 202 to the client device 202. When the update region is smaller than the search range, the server 201 is capable of reducing a data amount of the image data of an enlarged image to be transmitted. Further, an enlarged image is also reduced in size as well, so that it is possible to reduce a region which is to be hidden by an enlarged image displayed by the client device 202.

Further, the server 201 may transmit image data of an update region before update which includes a position of a touch operation performed on a screen of the client device 202 to the client device 202. Image data of an update region after update is image data in which a display content such as a button is changed by mouse over processing. Therefore, the image data of an update region after update is different from an image before enlargement when an enlarged image is displayed in the client device 202, having a possibility to confuse a user. Therefore, when image data before update is transmitted, the client device 202 merely displays an enlarged image which is obtained by enlarging an original image in display of the enlarged image on the client device 202, being able to avoid confusion of a user.

Here, the correction method described in the embodiments may be realized by executing a prepared program by a computer such as a personal computer or a work station. The correction program is recorded in a recording medium readable by a computer, such as hard disk, a flexible disk, a CD-ROM, an MO, and a DVD, and is executed by being read from the recording medium by a computer. Further, the correction program may be distributed through a network such as Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of controlling an information processing apparatus, the method comprising:
acquiring image information updated when an operation position specified based on operation information is set to a position different from the operation position; and
setting the operation position to the position based on the image information acquired in the acquiring.

2. The method according to claim 1, wherein
the position is one of positions in a range from the operation position.

3. The method according to claim 2, wherein
the acquiring acquires a plurality of pieces of the image information corresponding to the positions in the range, and
the method further comprises selecting the position from the positions based on the pieces of the image information acquired in the acquiring.

4. The method according to claim 3, wherein
the acquiring acquires a plurality of pieces of image information of a cursor of which the image information is updated when a position of the cursor is set to each of the positions in the range, and
the selecting selects the position based on a number of positions of pieces of the image information of the cursor that are same among the positions in the range.

5. The method according to claim 4, wherein
the selecting selects the position among positions of pieces of the image information of the cursor that are same is smallest.

6. The method according to claim 4, wherein
the selecting selects the position among positions at which a first line and a second line intersect with each other, and
the first line is formed by connecting first positions of the pieces of the image information of the cursor that are same to each other, and the second line is formed by connecting second positions different from the first positions of the pieces of the image information of the cursor that are same to each other.

7. The method according to claim 1, further comprising:
generating image information of an enlarged image obtained by enlarging an image of which the image information acquired in the acquiring; and
transmitting the image information generated in the generating to a terminal device coupled to the information processing apparatus, and
wherein the setting sets the operation position to the position based on operation information of an operation performed in the enlarged image displayed on the terminal device.

8. The method according to claim 1, comprising:
starting the acquiring when the information processing apparatus receives operation information of a specific operation from a terminal device coupled to the information processing apparatus.

9. The method according to claim 1, wherein
the operation information is input to a terminal device coupled to the information processing apparatus.

10. The method according to claim 3, further comprising:
calculating the range to be within a threshold value relative to the operation position.

11. The method according to claim 3, wherein the position is selected based on image information of an update region acquired for each of the positions.

12. A system including an information processing apparatus coupled to a terminal device, the information processing apparatus comprising:
a memory; and
a processor coupled to the memory and configured to:
acquire image information updated when an operation position specified based on operation information is set to a position different from the operation position; and
set the operation position to the position based on the image information.

13. The method according to claim 12, wherein
the position is one of positions in a range from the operation position.

14. The method according to claim 13, wherein
the acquiring acquires a plurality of pieces of the image information corresponding to the positions in the range, and
the method further comprises selecting the position from the positions based on the pieces of the image information acquired in the acquiring.

15. An information processing apparatus, comprising:
a memory; and
a processor coupled to the memory and configured to:
acquire image information updated when an operation position specified based on operation information is set to a position different from the operation position; and
set the operation position to the position based on the image information.

16. The method according to claim 15, wherein
the position is one of positions in a range from the operation position.

17. The method according to claim 16, wherein
the acquiring acquires a plurality of pieces of the image information corresponding to the positions in the range, and
the method further comprises selecting the position from the positions based on the pieces of the image information acquired in the acquiring.

18. A recording medium storing a program that causes an information processing apparatus to execute a procedure comprising:
acquiring image information updated when an operation position specified based on operation information is set to a position different from the operation position; and
setting the operation position to the position based on the image information.

19. The method according to claim 18, wherein
the position is one of positions in a range from the operation position.

20. The method according to claim 19, wherein
the acquiring acquires a plurality of pieces of the image information corresponding to the positions in the range, and
the method further comprises selecting the position from the positions based on the pieces of the image information acquired in the acquiring.
